(19) United States
(12) Patent Application Publication
(10) Pub. No.: US 2013/0247460 A1
(43) Pub. Date: Sep. 26, 2013

(54) METHODS FOR SEED PLANTING AND SELECTION

(71) Applicant: DOW AGROSCIENCES LLC, Indianapolis, IN (US)

(72) Inventors: Vanessa L. Schwoegler, Indianapolis, IN (US); Larry B. Rowland, Indianapolis, IN (US)

(73) Assignee: Dow AgroSciences LLC, Indianapolis, IN (US)

(21) Appl. No.: 13/780,403

(22) Filed: Feb. 28, 2013

Related U.S. Application Data
(60) Provisional application No. 61/603,976, filed on Feb. 28, 2012.

(51) Int. Cl. A01C 1/00; A01C 7/08

(52) U.S. Cl. CPC A01C 1/00; A01C 7/081
USPC 47/58.1 SE; 222/399

(57) ABSTRACT

This invention is related to methods and system for planting and selection. In particular, seeds from transformed plants or transformed explants are evenly dispenses on a pre-determined area using the methods and systems provided. The methods and systems disclosed use a combination of an air-powered or gas-assisted dispensing system to evenly dispense seeds or explants in a high throughput manner. In some embodiments, a 5-16 folds greater density than previous methods can be achieved with the systems and methods disclosed. In some embodiments, the air-powered systems disclosed can be modified from commercially available vacuum pen apparatus.

### CROSS-REFERENCE TO RELATED APPLICATIONS

This application claims priority under 35 U.S.C. §119 of U.S. provisional patent application Ser. No. 61/603,976 filed Feb. 28, 2012, which application is hereby incorporated by reference in its entirety.

### FIELD OF THE INVENTION

This invention is generally related to the field of agriculture, and more specifically the field of planting and selecting agronomic crops.

### BACKGROUND OF THE INVENTION

Several methodologies have been developed for introducing transgenes into plants to study gene functions. In general, these systems for producing transgenic plants have some common features: (1) a gene delivery system, (2) a selection system to differentiate transformed cells or plants from untransformed ones, and (3) a regeneration procedure to produce an entire plant (often fertile as well). Among all systems used, Agrobacterium-mediated gene transfer (in tissue culture) has been popular in recent years to generate transgenic plants.

A floral dip transformation method has been developed as an improvement upon Agrobacterium-mediated transformation of Arabidopsis (Clough and Bent, 1998, Plant J 16(6): 735-743). The floral dip method typically requires frequent multiple applications of dipping solution and is not suitable for high-throughput modifications. In addition to being labor intensive, results from floral dip methods are often unpredictable. It is possible to perform selection at different stages for transgenic plants. For example, selection can be applied either on Agrobacterium-transformed explants or seeds generated from the transformed plants.

Thus, there remains a need for a selection and/or plant method suitable for high-throughput applications in a consistent and/or concise manner.

### SUMMARY OF THE INVENTION

This invention is related to methods and system for planting and selection. In particular, seeds from transformed plants or transformed explants are evenly dispensed on a pre-determined area using the methods and systems provided. The methods and systems disclosed use a combination of an air-powered or gas-assisted dispensing system to evenly dispense seeds or explants in a high throughput manner. In some embodiments, a 5-16 folds greater density than previous methods can be achieved with the systems and methods disclosed. In some embodiments, a 5-10 folds greater density than previous methods can be achieved with the systems and methods disclosed. In some embodiments, at least ten (10) folds greater density than previous methods can be achieved with the systems and methods disclosed. In some embodiments, at least sixteen (16) folds greater density than previous methods can be achieved with the systems and methods disclosed. In some embodiments, the air-powered systems disclosed can be modified from commercially available vacuum pen apparatus.

In one aspect, provided is a system for dispensing or stratifying plant seeds or explants. The system comprises:

(a) an air supply;

(b) a pressure chamber;

(c) a regulatory valve;

(d) an air output fitting assembly; and

(e) a reservoir for retaining the plant seeds or explants.

In one embodiment, the plant seeds or explants are generated using a floral dip method. In another embodiment, the air supply is between 60 psi and 120 psi. In a further or alternative embodiment, the air supply is about 100 psi.

In one embodiment, air pressure of the pressure chamber is regulated by the regulatory valve. In another embodiment, the air output fitting assembly is directly connected to the reservoir for retaining the plant seeds or explants. In another embodiment, the air output fitting assembly comprises an output fitting adaptor which comprises a scoop-like deflector. In another embodiment, the reservoir for retaining the plant seeds or explants has a capacity to retain between 100 mg and 5000 mg plant seeds or explants. In a further or alternative embodiment, the plant seeds or explants retained by the reservoir are about 200 mg, 800 mg, 1,600 mg, or 3,200 mg.

In one embodiment, plant seeds or explants are evenly dispensed or stratified over a pre-determined area. In a further or alternative embodiment, the pre-determined area comprises a selection tray. In another embodiment, the system comprises a commercially available air-powered vacuum dispensing system. In another embodiment, the system comprises an air-powered EFD vacuum dispensing system from Nordson Corporation at Westlake, Ohio. In a further or alternative embodiment, the system comprises a modified EFD vacuum system. In some embodiment, the system does not comprise an air-pump.

In another aspect, provided is a method for planting seeds or explants. The method comprises:

(a) obtaining a plural of plant seeds or explants transformed with an Agrobacterium comprising an expression vector, wherein the expression vector comprises a selectable marker gene;

(b) stratifying the plant seeds or explants in a solid medium for a pre-determined period of time using an air-powered or gas-assisted dispensing system; and

(c) spraying the plant seeds or explants in a solid medium with a selective agent, wherein the selectable marker gene provides tolerance to the selective agent.

In one embodiment, the selectable marker provides glufosinate tolerance and the selective agent is glufosinate. In a further embodiment or alternative embodiment, the selectable marker is phosphinothricin acetyltransferase gene (pat) or bialaphos resistance gene (bar). In another embodiment, the selection agent is glyphosate or 2,4-D.

In one embodiment, the solid medium comprises agarose. In a further or alternative embodiment, the solid medium comprises between 0.01% to 2% agarose. In a further embodiment, the solid medium comprises between 0.05% to 0.25% agarose. In another embodiment, the pre-determined period of time is between one day and five days. In a further or alternative embodiment, the pre-determined period of time is about two days.

In one embodiment, wherein air-powered or gas assisted dispensing system comprises the system described herein. In another embodiment, the air-powered or gas-assisted dispensing system comprises a commercially available air-powered dispensing system. In a further or alternative embodiment, the system comprises an air-powered EFD vacuum system from Nordson Corporation at Westlake, Ohio. In a further embodiment, the system comprises a modified EFD vacuum system.

In one embodiment, the method increases throughput of seed planting for at least three folds as compared to a method without an air-powered dispensing system. In another embodiment, the method increases throughput of seed planting for at least five folds as compared to a method without an air-powered dispensing system. In a further embodiment, the method increases throughput of seed planting for at least ten folds as compared to a method without an air-powered dispensing system. In another embodiment, the method increases density of planted seeds for at least five folds as compared to a method without an air-powered dispensing system. In a further embodiment, the method increases density of planted seeds for at least ten folds as compared to a method without an air-powered dispensing system. In some embodiments, the air-powered system used by the method dose not comprises an air-pump.

### BRIEF DESCRIPTION OF THE DRAWINGS

FIG. 1A shows a typical existing dispensing system for planting seeds (the old method), where a pipette tip and an air pump are used.

FIG. 1B shows an exemplary embodiment of the systems provided herein (the improved method). The system shown here is a modified EFD vacuum pen from Nordson Corporation at Westlake, Ohio.

FIG. 2A shows a typical selection where seed planting is accomplished using an existing dispensing system (the old method).

FIG. 2B shows an exemplary embodiment of the method provided herein (the improved method). The method uses a system provided herein to produce plants with density greater than 10 folds as compared to the existing method.

FIG. 3 shows an exemplary air output fitting assembly described. FIG. 3A shows a standing alone output fitting adaptor. FIG. 3B shows an air output fitting assembly where the output fitting adaptor is placed over a spray nozzle when used.

FIG. 4 shows an exemplary embodiment of the system for dispensing or stratifying plant seeds or explants described.

### DETAILED DESCRIPTION OF THE INVENTION

The production of transgenic plants has become routine for many plant species, but the current methodologies are labor intensive and unpredictable. Thus, a goal of the methods and systems disclosed is to provide a selection and/or plant method suitable for high-throughput applications in a consistent and/or concise manner.

As used herein, the phrase “vector” refers to a piece of DNA, typically double-stranded, which can have inserted into it a piece of foreign DNA. The vector can be for example, of plasmid or viral origin, which typically encodes a selectable or screenable marker or transgenes. The vector is used to transport the foreign or heterologous DNA into a suitable host cell. Once in the host cell, the vector can replicate independently of or coincidental with the host chromosomal DNA. Alternatively, the vector can target insertion of the foreign or heterologous DNA into a host chromosome.

As used herein, the phrase “transgene vector” refers to a vector that contains an inserted segment of DNA, the “transgene” that is transcribed into mRNA or replicated as a RNA within a host cell. The phrase “transgene” refers not only to that portion of inserted DNA that is converted into RNA, but also those portions of the vector that are necessary for the transcription or replication of the RNA. A transgene typically comprises a gene-of-interest but needs not necessarily comprise a polynucleotide sequence that contains an open reading frame capable of producing a protein.

As used herein, the phrase “transformed” or “transformation” refers to the introduction of DNA into a cell. The phrases “transformant” or “transgenic” refers to plant cells, plants, and the like that have been transformed or have undergone a transformation procedure. The introduced DNA is usually in the form of a vector containing an inserted piece of DNA.

As used herein, the phrase “selectable marker” or “selectable marker gene” refers to a gene that is optionally used in plant transformation to, for example, protect the plant cells from a selective agent or provide resistance/tolerance to a selective agent. Only those cells or plants that receive a functional selectable marker are capable of dividing or growing under conditions having a selective agent. Examples of selective agents can include, for example, antibiotics, including spectinomycin, neomycin, kanamycin, paromomycin, gentamicin, and hygromycin. These selectable markers include gene for neomycin phosphotransferase (npt II), which expresses an enzyme conferring resistance to the antibiotic kanamycin, and genes for the related antibiotics neomycin, paromomycin, gentamicin, and G418, or the gene for hygromycin phosphotransferase (hpt), which expresses an enzyme conferring resistance to hygromycin. Other selectable marker genes can include genes encoding herbicide resistance including Bar (resistance against BASTA® (glufosinate ammonium), or phosphinothricin (PPT)), acetolactate synthase (ALS, resistance against inhibitors such as sulfonylureas (SUs), imidazolinones (IMIs), triazolopyrimidines (TPs), pyrimidinyl oxybenzoates (POBs), and sulfonylamino carbonyl triazolinones that prevent the first step in the synthesis of the branched-chain amino acids), glyphosate, 2,4-D, and metal resistance or sensitivity. The phrase “marker-positive” refers to plants that have been transformed to include the selectable marker gene.

Various selectable or detectable markers can be incorporated into the chosen expression vector to allow identification and selection of transformed plants, or transformants. Many methods are available to confirm the expression of selection markers in transformed plants, including for example DNA sequencing and PCR (polymerase chain reaction), Southern blotting, RNA blotting, immunological methods for detection of a protein expressed from the vector, e g., precipitated protein that mediates phosphinothricin resistance, or other proteins such as reporter genes β-glucuronidase (GUS), luciferase, green fluorescent protein (GFP), DsRed, β-galactosidase, chloramphenicol acetyltransferase (CAT), alkaline phosphatase, and the like (See Sambrook, et al., Molecular Cloning: A Laboratory Manual, Third Edition, Cold Spring Harbor Press, N.Y., 2001, the content of which is incorporated herein by reference in its entirety).

Selectable marker genes are utilized for the selection of transformed cells or tissues. Selectable marker genes include genes encoding antibiotic resistance, such as those encoding neomycin phosphotransferase II (NEO) and hygromycin phosphotransferase (HPT) as well as genes conferring resistance to herbicidal compounds. Herbicide resistance genes generally code for a modified target protein insensitive to the herbicide or for an enzyme that degrades or detoxifies the herbicide in the plant before it can act. See DeBlock et al. (1987) EMBO J., 6:2513-2518; DeBlock et al. (1989) Plant Physiol., 91:691-704; Fromm et al. (1990) 8:833-839; Gordon-Kamm et al. (1990) 2:603-618). For example, resistance to glyphosate or sulfonylurea herbicides has been obtained by using genes coding for the mutant target enzymes, 5-enolpyruvylshikimate-3-phosphate synthase (EPSPS) and acetolactate synthase (ALS). Resistance to glufosinate ammonium, bromoxynil, and 2,4-dichlorophenoxyacetate (2,4-D) have been obtained by using bacterial genes encoding phosphinothricin acetyltransferase, a nitrilase, or a 2,4-dichlorophenoxyacetate monooxygenase, which detoxify the respective herbicides. Enzymes/genes for 2,4-D resistance have been previously disclosed in US 2009/0093366 and WO 2007/053482, the contents of which are hereby incorporated by reference in their entireties.

Other herbicides can inhibit the growing point or meristem, including imidazolinone or sulfonylurea. Exemplary genes in this category code for mutant ALS and AHAS enzyme as described, for example, by Lee et al., EMBO J. 7:1241 (1988); and Miki et al., Theon. Appl. Genet. 80:449 (1990), respectively.

Glyphosate resistance genes include mutant 5-enolpyruvylshikimate-3-phosphate synthase (EPSPs) genes (via the introduction of recombinant nucleic acids and/or various forms of in vivo mutagenesis of native EPSPs genes), aroA genes and glyphosate acetyl transferase (GAT) genes, respectively). Resistance genes for other phosphono compounds include glufosinate (phosphinothricin acetyl transferase (PAT) genes from Streptomyces species, including Streptomyces hygroscopicus and Streptomyces viridichromogenes), and pyridinoxy or phenoxy proprionic acids and cyclohexones (ACCase inhibitor-encoding genes), See, for example, U.S. Pat. No. 4,940,835 to Shah, et al. and U.S. Pat. No. 6,248,876 to Barry et al., which disclose nucleotide sequences of forms of EPSPs which can confer glyphosate resistance to a plant. A DNA molecule encoding a mutant aroA gene can be obtained under ATCC accession number 39256, and the nucleotide sequence of the mutant gene is disclosed in U.S. Pat. No. 4,769,061 to Comai, European patent application No. 0 333 033 to Kumada et al., and U.S. Pat. No. 4,975,374 to Goodman et al., disclosing nucleotide sequences of glutamine synthetase genes which confer resistance to herbicides such as L-phosphinothricin. The nucleotide sequence of a PAT gene is provided in European application No. 0 242 246 to Leemans et al. Also DeGreef et al., Bio/Technology 7:61 (1989), describes the production of transgenic plants that express chimeric bar genes coding for PAT activity. Exemplary of genes conferring resistance to phenoxy proprionic acids and cyclohexones, including sethoxydim and haloxyfop, are the Accl-S1, Accl-S2 and Accl-S3 genes described by Marshall et al., Theon. Appl. Genet. 83:435 (1992). GAT genes capable of conferring glyphosate resistance are described in WO 2005012515 to Castle et al. Genes conferring resistance to 2,4-D, fop and pyridyloxy auxin herbicides are described in WO 2005107437 and U.S. patent application Ser. No. 11/587,893.

Other herbicides can inhibit photosynthesis, including triazine (psbA and 1s+ genes) or benzonitrile (nitrilase gene). Przibila et al., Plant Cell 3:169 (1991), describes the transformation of Chlamydomonas with plasmids encoding mutant psbA genes. Nucleotide sequences for nitrilase genes are disclosed in U.S. Pat. No. 4,810,648 to Stalker, and DNA molecules containing these genes are available under ATCC Accession Nos. 53435, 67441, and 67442. Cloning and expression of DNA coding for a glutathione S-transferase is described by Hayes et al., Biochem. J. 285:173 (1992).

For purposes of the present invention, selectable marker genes include, but are not limited to genes encoding: neomycin phosphotransferase II (Fraley et al. (1986) CRC Critical Reviews in Plant Science, 4:1-25); cyanamide hydratase (Maier-Greiner et al. (1991) Proc. Natl. Acad. Sci. USA, 88:4250-4264); aspartate kinase; dihydrodipicolinate synthase (Perl et al. (1993) Bio/Technology, 11:715-718); tryptophan decarboxylase (Goddijn et al. (1993) Plant Mol. Bio., 22:907-912); dihydrodipicolinate synthase and desensitized aspartade kinase (Perl et al. (1993) Bio/Technology, 11:715-718); bar gene (Toki et al. (1992) Plant Physiol., 100:1503-1507 and Meagher et al. (1996) and Crop Sci., 36:1367); tryptophan decarboxylase (Goddijn et al. (1993) Plant Mol. Biol., 22:907-912); neomycin phosphotransferase (NEO) (Southern et al. (1982) J. Mol. Appl. Gen., 1:327; hygromycin phosphotransferase (HPT or HYG) (Shimizu et al. (1986) Mol. Cell Biol., 6:1074); dihydrofolate reductase (DHFR) (Kwok et al. (1986) PNAS USA 4552); phosphinothricin acetyltransferase (DeBlock et al. (1987) EMBO J., 6:2513); 2,2-dichloropropionic acid dehalogenase (Buchanan-Wollatron et al. (1989) J. Cell. Biochem. 13D:330); acetohydroxyacid synthase (Anderson et al., U.S. Pat. No. 4,761,373; Haughn et al. (1988) Mol. Gen. Genet. 221:266); 5-enolpyruvyl-shikimate-phosphate synthase (aroA) (Comai et al. (1985) Nature 317:741); haloarylnitrilase (Stalker et al., published PCT application WO87/04181); acetyl-coenzyme A carboxylase (Parker et al. (1990) Plant Physiol. 92:1220); dihydropteroate synthase (sul I) (Guerineau et al. (1990) Plant Mol. Biol. 15:127); and 32 kD photosystem II polypeptide (psbA) (Hirschberg et al. (1983) Science, 222:1346).

Also included are genes encoding resistance to: chloramphenicol (Herrera-Estrella et al. (1983) EMBO J., 2:987-992); methotrexate (Herrera-Estrella et al. (1983) Nature, 303:209-213; Meijer et al. (1991) Plant Mol Bio., 16:807-820 (1991); hygromycin (Waldron et al. (1985) Plant Mol. Biol., 5:103-108; Zhijian et al. (1995) Plant Science, 108:219-227 and Meijer et al. (1991) Plant Mol. Bio. 16:807-820); streptomycin (Jones et al. (1987) Mol. Gen. Genet., 210:86-91); spectinomycin (Bretagne-Sagnard et al. (1996) Transgenic Res., 5:131-137); bleomycin (Hille et al. (1986) Plant Mol. Biol., 7:171-176); sulfonamide (Guerineau et al. (1990) Plant Mol. Bio., 15:127-136); bromoxynil (Stalker et al. (1988) Science, 242:419-423); 2,4-D (Streber et al. (1989) Bio/Technology, 7:811-816); glyphosate (Shaw et al. (1986) Science, 233:478-481); and phosphinothricin (DeBlock et al. (1987) EMBO J., 6:2513-2518). All references recited in the disclosure are hereby incorporated by reference in their entireties unless stated otherwise.

The above list of selectable marker and reporter genes are not meant to be limiting. Any reporter or selectable marker gene are encompassed by the present invention. If necessary, such genes can be sequenced by methods known in the art.

The reporter and selectable marker genes are synthesized for optimal expression in the plant. That is, the coding sequence of the gene has been modified to enhance expression in plants. The synthetic marker gene is designed to be expressed in plants at a higher level resulting in higher transformation efficiency. Methods for synthetic optimization of genes are available in the art. In fact, several genes have been optimized to increase expression of the gene product in plants.

The marker gene sequence can be optimized for expression in a particular plant species or alternatively can be modified for optimal expression in plant families. The plant preferred codons may be determined from the codons of highest frequency in the proteins expressed in the largest amount in the particular plant species of interest. See, for example, EPA 0359472; EPA 0385962; WO 91/16432; Perlak et al. (1991) Proc. Natl. Acad. Sci. USA, 88:3324-3328; and Murray et al. (1989) Nucleic Acids Research, 17: 477-498; U.S. Pat. No. 5,380,831; and U.S. Pat. No. 5,436,391, herein incorporated by reference. In this manner, the nucleotide sequences can be optimized for expression in any plant. It is recognized that all or any part of the gene sequence may be optimized or synthetic. That is, fully optimized or partially optimized sequences may also be used.

In addition, several transformation strategies utilizing the Agrobacterium-mediated transformation system have been developed. For example, the binary vector strategy is based on a two-plasmid system where T-DNA is in a different plasmid from the rest of the Ti plasmid. In a co-integration strategy, a small portion of the T-DNA is placed in the same vector as the foreign gene, which vector subsequently recombines with the Ti plasmid.

As used herein, the phrase “explant” refers to a removed section of living tissue or organ from one or more tissues or organs of a subject.

As used herein, the phrase “plant” includes dicotyledons plants and monocotyledons plants. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale.

Existing floral-dip and floral-spray transformation and selection methods have been disclosed in Li et al., 2010, International Journal of Biology 2(1): 127-131 and Chung et at., 2000, Transgenic Research 9: 471-476, the contents of which are herein incorporated by reference in their entireties.

The methods and systems provided allow a significant greater amount of seeds or explant to be dispensed per selection tray especially useful for transgenic plants selection. The methods and systems disclosed provide at least two advantages: (1) the selective agent is added into a solid medium during stratification, thus enabling a more effective selection process; (2) the plant seeds or explants are evenly dispensed onto a selection tray in a high throughput manner to achieve greater density of seeds planted. The selective agent inhibits growth of non-resistant or non-tolerant plants, and therefore overgrowing is prevented. Accordingly, although the methods disclosed start with a high density of seeds or explants in a selection tray, the plants grown after selection maintain a reasonable density for the plants for subsequent biological or chemical testing. A typically example of the methods disclosed can achieve at least ten folds or sixteen folds increase of the density of seeds or explant planted.

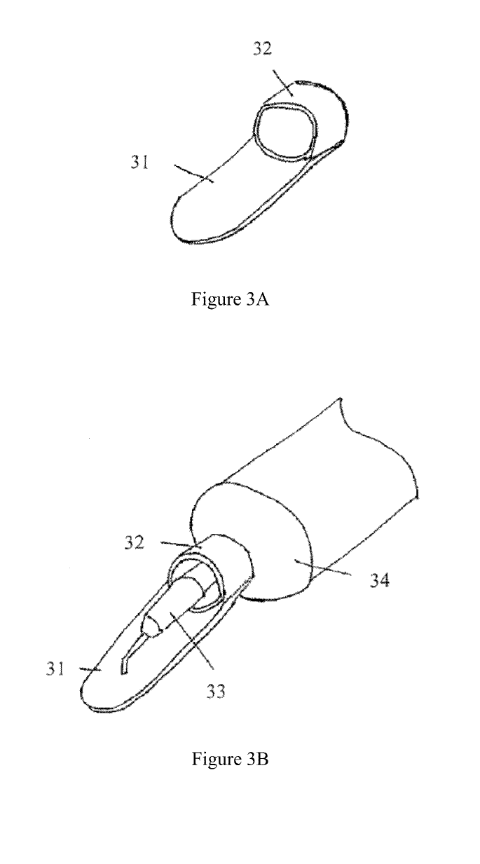

An exemplary air output fitting assembly described is shown in FIG. 3. FIG. 3A shows a standing alone output fitting adaptor comprising a scoop-like deflector (31) for deflecting the seeds and a ring-like fitting (32) to be placed and secured onto a reservoir for spraying seeds or explants (for example syringe tube). FIG. 3B shows an air output fitting assembly where the output fitting adaptor (31 and 32) is placed over a spray nozzle (33) which is connected to a reservoir for spraying seeds or explants (34).

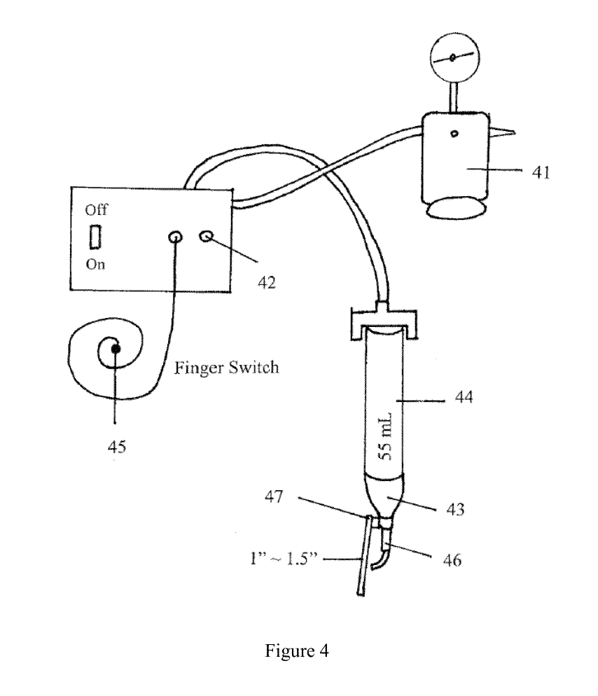

An exemplary embodiment of the system for dispensing or stratifying plant seeds or explants described is illustrated in FIG. 4. A pressure regulator (41), a regulatory valve (42), an air output fitting assembly (47), and a reservoir for retaining the seeds or explants (43 and 44) are shown. Also shown is a finger switch (45) and spray nozzle (46). The reservoir for retaining the seeds or explants in this case is a 55 mL syringe tube where the air output fitting assembly (47) can be secured on the tapered part (43) and the tube part (44) is used for retaining seeds when used for spraying.

### EXAMPLES

### Example 1

The Methods Provided Dramatically Increase Throughput of Planted Seeds

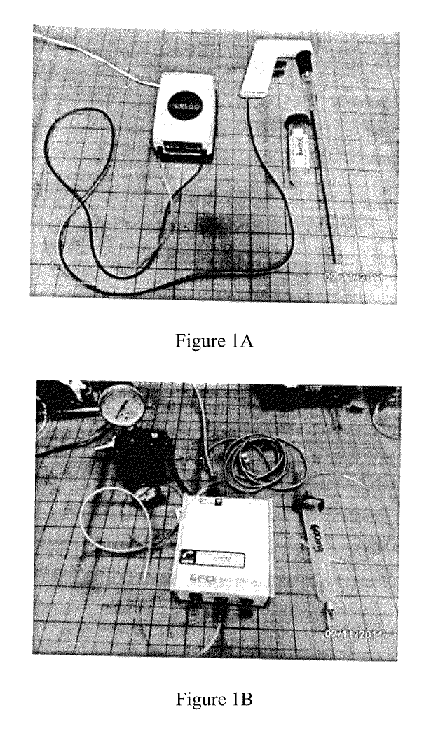

An existing dispensing system for planting seeds uses a simple pipette with an air pump (as shown in FIG. 1A). This existing system is slow and labor intensive. It also often fails to evenly dispense seeds over an entire selection tray. A typical selection tray used has a dimension of about 21.25″×10.81″×1.29″. Typically 200 mg (˜10,000 seeds) of Arabidopsis seeds in a liquid medium containing a selective agent (for example, glufosinate, glyphosate, or 2,4-D) can be dispensed onto a selection tray using a 40 ml pipette. After dispensed onto the selection tray, the seeds are incubated for two days in a green house. The seeds are dispensed in the liquid medium for two days and once dispensed onto selection trays, the seeds are kept in a growth chamber/green house until maturity. The selective agent can be repeated applied by spraying on top of the seeds or plants to further strengthen the selection if necessary.

An exemplary embodiment of the methods and systems disclosed uses an air-powered dispensing system (as shown in FIG. 1B). The methods and systems disclosed allow high throughput applications and can evenly dispense seeds over a wide area. Importantly, 3,200 mg of Arabidopsis seeds in a medium containing 0.1% agarose and a selective agent (for example, glufosinate, glyphosate, or 2,4-D) can be evenly dispensed onto a selection tray. The selective agent can be repeated applied by spraying on top of the seeds or plants to further strengthen the selection if necessary.

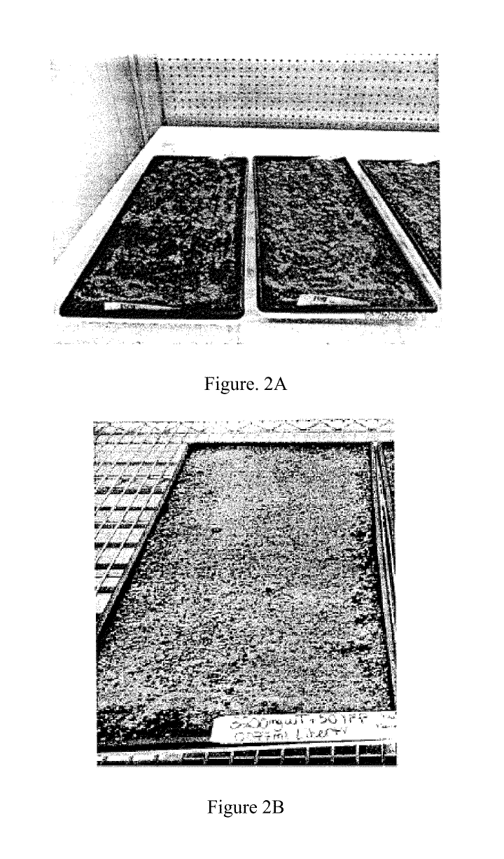

Two weeks after planting, the selection trays from both the existing method (shown in FIG. 2A) and the methods disclosed (shown in FIG. 2B) are compared. The selection trays from the methods disclosed shows dramatically improved density for the plants grown from the planted seeds, where at least ten-fold increase of plant (or seed) density can be routinely observed, either before or after the selection. The survival range is from 0 to 70 with an average of 27.

To test the efficiency of the method disclosed, fifty (50) known resistant seeds are spiked into higher amounts of non-resistant wild-type seed seeds of 800 mg, 1600 mg, or 3,200 mg into each reservoir (for example syringe tube) to see how many of the 50 seeds can be recovered.

Three representative normal production experiments are shown in Table 1, showing growth of seeds dipped in Agrobacterium.

TABLE 1
Growth of herbicide resistant seeds

| Old Method (200 mg seeds) | | Improved Method (600 mg seeds) | |
|---|---|---|---|
| Exp 1 | 13 | Exp 1 | 44 |
| Exp 2 | 9 | Exp 2 | 33 |
| Exp 3 | 16 | Exp 3 | 47 |
| Average | 12.66 | Average | 41.33 |

We claim:

1. A system for dispensing or stratifying plant seeds or explants, comprising,
(a) an air supply;
(b) a pressure chamber;
(c) a regulatory valve;
(d) an air output fitting assembly; and
(e) a reservoir for retaining the plant seeds or explants.

2. The system of claim 1, wherein the plant seeds or explants are generated using a floral dip method.

3. The system of claim 1, wherein the air supply is between 60 psi and 120 psi.

4. The system of claim 1, wherein the air supply is about 100 psi.

5. The system of claim 1, wherein air pressure of the pressure chamber is regulated by the regulatory valve.

6. The system of claim 1, wherein the air output fitting assembly is directly connected to the reservoir for retaining the plant seeds or explants.

7. The system of claim 1, wherein the air output fitting assembly comprises an output fitting adaptor which comprises a scoop-like deflector.

8. The system of claim 1, wherein the reservoir for retaining the plant seeds or explants has a capacity to retain between 100 mg and 5000 mg plant seeds.

9. The system of claim 1, wherein plant seeds are evenly dispensed or stratified over a pre-determined area.

10. The system of claim 9, wherein the pre-determined area comprises a selection tray.

11. The system of claim 1, wherein the system comprises an air-powered EFD vacuum system from Nordson Corporation.

12. A method for planting seeds or explants, comprising,
(a) obtaining a plural of plant seed transformed with an Agrobacterium comprising an expression vector, wherein the expression vector comprises a selectable marker gene;
(b) stratifying the plant seeds in a solid medium for a pre-determined period of time using an air-powered or gas-assisted dispensing system; and
(c) spraying the plant seeds in a solid medium with a selective agent, wherein the selectable marker gene provides tolerance to the selective agent.

13. The method of claim 12, wherein the selectable marker provides glufosinate tolerance and the selective agent is glufosinate.

14. The method of claim 13, wherein the selectable marker is phosphinothricin acetyltransferase gene (pat) or bialaphos resistance gene (bar).

15. The method of claim 12, wherein the solid medium comprises agarose.

16. The method of claim 15, wherein the solid medium comprises between 0.01% to 2% agarose.

17. The method of claim 15, wherein the solid medium comprises between 0.05% to 0.25% agarose.

18. The method of claim 12, wherein the pre-determined period of time is between one day and 5 days.

19. The method of claim 18, wherein the pre-determined period of time is about two days.

20. The method of claim 12, wherein air-powered or gas assisted dispensing system comprises the system of claim 1.

21. The method of claim 20, wherein the system comprises an air-powered EFD vacuum system from Nordson Corporation.

22. The method of claim 12, wherein the method increases throughput of seed planting for at least five folds as compared to a method without an air-powered dispensing system.

23. The method of claim 12, wherein the method increases throughput of seed planting for at least ten folds as compared to a method without an air-powered dispensing system.

24. The method of claim 12, wherein the method increases density of planted seeds for at least five folds as compared to a method without an air-powered dispensing system.

25. The method of claim 12, wherein the method increases density of planted seeds for at least ten folds as compared to a method without an air-powered dispensing system.
